(19) United States
(12) Patent Application Publication
(10) Pub. No.: US 2025/0250510 A1
(43) Pub. Date: Aug. 7, 2025

(54) DETERGENT COMPOSITION FOR AUTOMATIC DISHWASHERS

(71) Applicant: Kao Corporation, Tokyo (JP)

(72) Inventors: Takuji KAWAMURA, Wakayama-shi (JP); Kenji HOZUMI, Wakayama-shi (JP)

(73) Assignee: Kao Corporation, Tokyo (JP)

(21) Appl. No.: 18/855,113

(22) PCT Filed: Apr. 17, 2023
(86) PCT No.: PCT/JP2023/015319

§ 371 Date: Oct. 8, 2024

(30) Foreign Application Priority Data
Apr. 18, 2022 (JP) 2022-067981

(51) Int. Cl. C11D 3/00; C11D 1/722; C11D 3/04

(52) U.S. Cl. CPC C11D 3/0084; C11D 1/722; C11D 3/046

(57) ABSTRACT

A detergent composition for automatic dishwashers and a method for washing tableware is described. The detergent composition contains component (a): an inorganic reducing agent with an oxidation-reduction potential of +71 mV or less; and component (b): a nonionic surfactant; and water. A mass ratio of the component (a) to the component (b), (a)/(b), is 0.3 to 4.5, and a pH of the detergent composition at 25° C. is 6 to 11. The detergent composition is effective for washing complex soil containing animal protein and lipid and containing vegetable liquid oil even if a liquid property is in the region of neutrality to weak alkalinity.

### FIELD OF THE INVENTION

The present invention relates to a detergent composition for automatic dishwashers and a method for washing tableware.

### BACKGROUND OF THE INVENTION

Dishwashers are used for washing tableware such as dirty dishes, glasses, cooking utensils or the like in kitchens of households, restaurants, coffee shops or the like and for washing plastic containers for foodstuffs and products used in food and beverage manufacturing plants. Main target soils are protein, starch, oils and fats or the like derived from food, and these soils combine together to adhere to tableware such as dishes, glasses, cooking utensils or the like or plastic containers. Further, in some cases, these soils are heat-denatured during heating cooking to be stubborn soil and stick thereto.

Washing with a dishwasher is usually carried out in the order of a washing process and a rinsing process. The time required for these processes is very short in a business use, and about 40 to 180 seconds for a washing process and about 5 to 20 seconds for a rinsing process in process design. However, in the case of stubborn soil, such a designed time may result in insufficient washing, and it is not uncommon for a washing process to take several times longer than designed to achieve sufficient washing. In particular, protein-containing soil is difficult to remove, and thus strong alkaline detergents are generally used. However, strong alkaline detergents are difficult to handle, and techniques are required to clean protein-containing soil in a short time even in the near neutral condition.

JP-A 2021-91838 discloses a technique of a liquid detergent composition for dishwashers containing a nonionic surfactant such as alkyl glycoside and polyoxyethylene alkyl ether, and the publication states that a very small amount of reducing agent is effective in reducing gas generation.

JP-A 2016-522279 discloses a technique for applying a very small amount of reducing agent to stabilize a perfume ingredient in a detergent composition containing a nonionic surfactant.

JP-A 9-78099 discloses a technique for applying a reducing agent to stabilize fragrance in a powder detergent containing a nonionic surfactant.

### SUMMARY OF THE INVENTION

Among various types of soil adhering to tableware, complex soil containing protein and lipid tends to be altered and solidified easily, and is difficult to remove in a short washing time in dishwashers for business use. Particularly, egg yolk causes stubborn sticking of soil depending on the state of alteration of soil which has been dried, denatured or the like over time after soil adhesion, making short-time washing more difficult. In order to effectively wash protein- and lipid-containing soil in a short time, washing under strongly alkaline conditions is forced to be performed in the current situation; however, considering the impact on workers and the environment, it is desirable to use solutions with a liquid property being in the region of neutrality to weak alkalinity. Further, in actual dishwashing, soil is not merely animal protein soil, but is in general compounded due to use of vegetable liquid oil in cooking.

The present invention provides a detergent composition for automatic dishwashers capable of effectively washing complex soil containing animal protein and lipid and containing vegetable liquid oil by washing with a dishwasher even if a liquid property is in the region of neutrality to weak alkalinity, and a method for washing tableware.

The present invention relates to a detergent composition for automatic dishwashers, containing the following component (a), the following component (b) and water,
component (a): an inorganic reducing agent with an oxidation-reduction potential of +71 mV or less; and
component (b): a nonionic surfactant,
wherein a mass ratio of a content of component (a) to a content of component (b), (a)/(b), is 0.3 or more and 4.5 or less, and a pH of the composition at 25° C. is 6 or more and 11 or less.

Further, the present invention relates to a method for washing tableware including, washing, by using an automatic dishwasher, tableware adhered with soil with a washing liquid prepared by diluting the detergent composition for automatic dishwashers of the present invention with water.

According to the present invention, provided are a detergent composition for automatic dishwashers capable of effectively washing complex soil containing animal protein and lipid and containing vegetable liquid oil by washing with a dishwasher even if a liquid property is in the region of neutrality to weak alkalinity, and a method for washing tableware.

### EMBODIMENTS OF THE INVENTION

It is not wholly certain why the detergent composition for automatic dishwashers and the method for washing tableware of the present invention can achieve effective washing of complex soil containing animal protein and lipid and vegetable liquid oil, for example, complex soil containing egg yolk protein and salad oil, by washing with a dishwasher even if a liquid property is in the region of neutrality to weak alkalinity, but it is inferred to be as follows.

As a result of analyzing protein soil difficult to wash such as dried egg yolk soil or the like, the present inventors found that a factor in making such soil less likely to be removed or dispersed by surfactants or the like contained in detergents is ascribable to the fact that disulfide bonds (—SS— bonds) within protein molecules or between molecules in a protein structure stabilize the structure, and protein contained in the protein soil difficult to wash forms a structure in which swelling or dispersion by surfactants is less likely to occur. It is then considered that in the detergent composition for automatic dishwashers of the present invention, an inorganic reducing agent with a specific oxidation-reduction potential, which is component (a), is used to cleave the disulfide bonds in the protein structure contained in protein soil difficult to wash, and thus the protein soil difficult to wash can be easily removed from tableware and dispersed in water even if the detergent composition has a pH in the region of neutrality to weak alkalinity. It is then considered that it is important for an inorganic reducing agent of component (a) to have reducibility capable of cleaving disulfide bonds, and if component (a) has an oxidation-reduction potential equal to or less than +71 mV which is an oxidation-reduction potential of disulfide bonds, disulfide bonds can be cleaved to a sufficient degree even in a short washing time for a dishwasher for business use. Further, in actual dishwashing, soil is not merely animal protein soil, but is in general compounded due to use of vegetable liquid oil in cooking. For example, when a topmost surface of protein soil adhered to tableware is covered with liquid oil, the protein soil has a structure on which component (a) is difficult to act. Thus, in the present invention, it is considered that by using component (b) which enhances the emulsifying power of vegetable oil in addition to component (a), protein soil is removed while liquid oil is removed, and this synergistically produces high washing effects.

Note that the acting mechanism by which the present invention exhibits its effect is not limited to the above.

### Detergent Composition for Automatic Dishwashers

<Component (a)>

Component (a) is an inorganic reducing agent with an oxidation-reduction potential of +71 mV or less.

An oxidation-reduction potential of component (a) is +71 mV or less, preferably +60 mV or less, more preferably +55 mV or less and further preferably +50 mV or less from the viewpoint of protein washing performance. Further, the lower a lower limit of an oxidation-reduction potential of component (a) is, the more the effect can be expected, and it is not particularly limited to, but preferably 0 mV or more and more preferably 3 mV or more from the viewpoint of availability.

As an oxidation-reduction potential of component (a), a value measured by the following method is used. Distilled water is added to component (a) such that the concentration is 0.016 mol/L, and 1 mol/L hydrochloric acid and/or sodium hydroxide are added to adjust the pH to 7.5 to prepare a conditioned liquid. The temperature of the conditioned liquid is adjusted to 60° C., and the oxidation-reduction potential is measured with an oxidation-reduction potentiometer (for example, an ORP measuring instrument manufactured by CEM corporation Co., Ltd. (ORP5 PEN ORP meter)).

Component (a) is specifically one or more selected from a sulfite, a disulfate, a thiosulfate and an iodide salt, and specific examples include one or more selected from sodium sulfite (+50 mV), potassium sulfite (+50 mV), sodium disulfate (+17 mV), potassium disulfate (+17 mV), potassium iodide (+28 mV), sodium iodide (+28 mV), sodium thiosulfate (+5 mV) and potassium thiosulfate (+5 mV). Component (a) is not particularly limited as long as it has an oxidation-reduction potential of +71 mV or less, but preferably one or more selected from sodium sulfite, sodium disulfate, potassium iodide and sodium thiosulfate, more preferably one or more selected from sodium sulfite, sodium disulfate and sodium thiosulfate, further preferably one or more selected from sodium sulfite and sodium thiosulfate, and furthermore preferably sodium sulfite from the viewpoints of protein washing performance and availability. Note that shown in parentheses are oxidation-reduction potential values.

<Component (b)>

Component (b) is a nonionic surfactant.

As component (b), one or more selected from a compound represented by the following general formula (b1), a compound represented by the following general formula (b2) and a compound represented by the following general formula (b3) are preferred, and a compound represented by the following general formula (b1) is more preferred from the viewpoints of low-foaming properties and emulsifying power of liquid oil:

R^{1b}—O-[(EO)ₘ/(PO)ₙ]-H (b1)

wherein R^{1b} is a hydrocarbon group with 6 or more and 18 or less carbons, EO represents an ethyleneoxy group, PO represents a propyleneoxy group, m represents an average number of added moles of EO, n represents an average number of added moles of PO, m is a number of 1 or more and 30 or less, n is a number of 2 or more and 50 or less, and “/” means that EO and PO may be at random or in block, the order of addition of EO and PO being arbitrary,

H—O-(EO)ₐ-(PO)_{b}-(EO)_{c}-H (b2) and

H—O-(PO)_{d}-(EO)ₑ-(PO)_{f}-H (b3)

wherein EO represents an oxyethylene group, PO represents an oxypropylene group, and a, b, c, d, e and f are average numbers of added moles, and each independently a number of 2 or more and 30 or less.

R^{1b} in the general formula (b1) is a hydrocarbon group, preferably an alkyl group or an alkenyl group, more preferably a linear alkyl group or a branched alkyl group and further preferably a branched alkyl group with 6 or more and 18 or less carbons. The branched alkyl group of R^{1b} is exemplified by a branched primary alkyl group or a branched secondary alkyl group, and is preferably a branched secondary alkyl group. The branched primary alkyl group refers to a residue of a branched primary alcohol from which a hydroxyl group has been removed, and the carbon atom in R^{1b} bonded to O— in R^{1b}O— in the general formula (b1) is a primary carbon atom. Further, the branched secondary alkyl group refers to a residue of a secondary alcohol from which a hydroxyl group has been removed, and the carbon atom in R^{1b} bonded to O— in R^{1b}O— in the general formula (b1) is a secondary carbon atom.

R^{1b} has 6 or more, preferably 8 or more, more preferably 10 or more, and further preferably 12 or more carbons and 18 or less, preferably 16 or less, and more preferably 14 or less carbons from the viewpoints of emulsifying power of liquid oil and uniform stabilization of the detergent composition.

Further, in the general formula (b1), m, which is an average number of added moles of EO, is 1 or more, preferably 3 or more and more preferably 5 or more, and 30 or less, preferably 20 or less, more preferably 15 or less and further preferably 10 or less from the viewpoints of emulsifying power of liquid oil, anti-foaming performance in washing and uniform stabilization of the detergent composition.

Further, in the general formula (b1), n, which is an average number of added moles of PO, is 2 or more, preferably 5 or more and more preferably 7 or more, and 50 or less, preferably 40 or less, more preferably 30 or less, further preferably 20 or less, and furthermore preferably 10 or less from the viewpoints of emulsifying power of liquid oil and anti-foaming performance in washing.

In the general formulas (b2) and (b3), a, b, c, d, e and f are average numbers of added moles, and each independently a number of 1 or more, preferably 2 or more and more preferably 5 or more, and 30 or less, preferably 25 or less and more preferably 20 or less from the viewpoints of emulsifying power of liquid oil and anti-foaming performance in washing.

It is preferable that in the compound represented by the general formula (b2) or (b3), a, b, c, d, e and f be selected to satisfy that the compound includes preferably 5 mol % or more, more preferably 10 mol % or more and further preferably 15 mol % or more, and preferably 90 mol % or less, more preferably 70 mol % or less, further preferably 60 mol % or less, furthermore preferably 50 mol % or less, furthermore preferably 40 mol % or less, furthermore preferably 30 mol % or less, and furthermore preferably 25 mol % or less of EO based on the total amount of EO and PO from the viewpoints of emulsifying power of liquid oil and anti-foaming performance in washing.

The compound represented by the general formula (b2) or (b3) has a weight average molecular weight of preferably 500 or more, more preferably 700 or more, further preferably 1,000 or more and furthermore preferably 2,000 or more, and preferably 20,000 or less, more preferably 10,000 or less, further preferably 8,000 or less, furthermore preferably 6,000 or less, and furthermore preferably 4,000 or less from the viewpoints of emulsifying power of liquid oil, anti-foaming performance in washing and uniform stabilization of the detergent composition.

The compound represented by the general formula (b2) is available from ADEKA Corporation under the product name “Pluronic.” The compound represented by the general formula (b3) is available from BASF under the product name “Pluronic R.”

### <Composition and Others>

The detergent composition for automatic dishwashers of the present invention can contain component (a) in an amount of preferably 0.5 mass % or more, more preferably 0.7 mass % or more, further preferably 1 mass % or more and furthermore preferably 2 mass % or more, and preferably 20 mass % or less, more preferably 18 mass % or less, further preferably 15 mass % or less, furthermore preferably 10 mass % or less, furthermore preferably 5 mass % or less and furthermore preferably 3 mass % or less in the detergent composition from the viewpoint of washing performance for protein in complex soil containing protein and liquid oil.

The detergent composition for automatic dishwashers of the present invention can contain component (b) in an amount of preferably 0.6 mass % or more, more preferably 0.7 mass % or more, further preferably 0.8 mass % or more, furthermore preferably 1 mass % or more and furthermore preferably 2 mass % or more, and preferably 20 mass % or less, more preferably 18 mass % or less, further preferably 15 mass % or less, furthermore preferably 10 mass % or less, furthermore preferably 5 mass % or less and furthermore preferably 3 mass % or less in the detergent composition from the viewpoint of washing performance for liquid oil in complex soil containing protein and liquid oil.

In the detergent composition for automatic dishwashers of the present invention, a mass ratio of the content of component (a) to the content of component (b), (a)/(b), is 0.3 or more, preferably 0.5 or more and more preferably 1 or more, and 4.5 or less, preferably 4 or less, more preferably 3 or less, further preferably 2 or less, and furthermore preferably 1.5 or less from the viewpoints of washing performance for complex soil containing protein and liquid oil and finishing of tableware after washing.

In the detergent composition for automatic dishwashers of the present invention, the ranges of the contents of component (a) and component (b) can each be set by arbitrarily selecting numerical values described above and combining them.

A pH of the detergent composition for automatic dishwashers of the present invention at 25° C. is 6 or more, preferably 6.2 or more and more preferably 6.5 or more, and 11 or less, preferably 10 or less, more preferably 9 or less, further preferably 8 or less and furthermore preferably 7 or less from the viewpoint of reducing the risk of chemical injuries. This pH is measured by the measurement method below.

### (1) pH Measurement Method

A composite electrode for pH measurements (for example, a glass slide-in sleeve type manufactured by HORIBA, Ltd.) with a saturated potassium chloride aqueous solution (3.33 mol/L) as the pH electrode internal solution is connected to a pH meter (for example, pH/ion meter F-23 manufactured by HORIBA, Ltd.). Next, a pH 4.01 standard solution (phthalate standard solution), a pH 6.86 standard solution (neutral phosphate standard solution) and a pH 9.18 standard solution (borate standard solution) are each filled into a 100 mL-beaker, and immersed in a constant temperature bath at 25° C. for 30 minutes. The electrode for pH measurements is immersed in the standard solutions adjusted to be at a constant temperature for 3 minutes to perform a calibration operation in the order of pH 6.86, pH 9.18 and pH 4.01. The temperature of the detergent composition for automatic dishwashers to be measured is adjusted to 25° C., the electrode of the pH meter is immersed in the sample, and the pH 1 minute later is measured.

A pH at 25° C. of a diluted product of the detergent composition for automatic dishwashers of the present invention diluted with water at a concentration of 0.2 mass % is preferably 6 or more and more preferably 6.5 or more, and preferably 10.5 or less, more preferably 9 or less and further preferably 8 or less from the viewpoints of reducing the risk of chemical injuries and reducing environmental burdens by reducing the pH of wastewater. This pH is measured by the above measurement method (provided that the detergent composition for automatic dishwashers is read as the diluted product of the detergent composition for automatic dishwashers).

The detergent composition for automatic dishwashers of the present invention preferably contains water from the viewpoints of stability of the detergent composition and workability. Examples of water are not particularly limited to, but include tap water, well water, ion exchange water, distilled water or the like. Water is preferably used in an amount of the balance of the detergent composition (an amount making the total 100 mass %). A content of water in the detergent composition can be, for example, 20 mass % or more, further 30 mass % or more, further 50 mass % or more, further 55 mass % or more, further 60 mass8 or more, further 65 mass % or more and further 70 mass % or more.

The detergent composition for automatic dishwashers of the present invention can be formulated with components such as a surfactant, an enzyme (a proteolytic enzyme, a lipolytic enzyme, a glycolytic enzyme or the like), a solvent, a hydrotropic agent, a dispersant, a pH adjuster, a thickener, a viscosity adjuster, a fragrance, a colorant, an anti-oxidant, an antiseptic, an anti-foaming agent, a bleaching agent, a bleach activator or the like (excluding those qualifying for components (a) to (b)) in the range that the purpose of the present invention is not impaired.

A viscosity of the detergent composition for automatic dishwashers of the present invention at 20° C. may be, for example, 1,200 mPa·s or less and further 1,000 mPa·s or less from the viewpoint of securing a stable detergent supply amount when using a detergent supplying device. A lower limit of the viscosity may be 0 mPa·s or more. This viscosity is measured with a B-type viscometer.

In the present invention, tableware may mean to include members or utensils coming in contact with foodstuffs such as,
in addition to (i) so-called tableware such as a dish, a bowl, a cup, chopsticks, a knife, a fork, a spoon or the like,
(ii) storage containers such as Tupperware, a bottle or the like,
(iii) cooking utensils such as a kitchen knife, a chopping board, a pan, a frying pan, a fish grill or the like and
(iv) containing or carrying utensils such as a rack, a container or the like, and others.

### <Method for Washing Tableware>

The present invention provides a method for washing tableware including, washing, by using an automatic dishwasher, tableware adhered with soil with a washing liquid prepared by diluting the detergent composition for automatic dishwashers of the present invention with water (hereinafter referred to as the washing liquid of the present invention).

The matters stated in the detergent composition for automatic dishwashers of the present invention can be appropriately applied to the method for washing tableware of the present invention. The specific examples or preferable examples of component (a), component (b), mass ratio (a)/(b), pH and tableware are also the same as in the aspect described in the detergent composition for automatic dishwashers of the present invention.

The washing liquid of the present invention may be prepared by diluting the detergent composition for automatic dishwashers of the present invention with water by a factor of more than one and further 300 or more, and 2000 or less and further 1500 or less.

The washing liquid of the present invention can contain component (a) in an amount of preferably 0.0001 mass % or more, more preferably 0.0002 mass % or more, further preferably 0.0003 mass % or more, furthermore preferably 0.0005 mass % or more, furthermore preferably 0.001 mass % or more, furthermore preferably 0.002 mass % or more and furthermore preferably 0.003 mass % or more, and preferably 5 mass % or less, more preferably 1 mass % or less, further preferably 0.1 mass % or less and furthermore preferably 0.01 mass % or less from the viewpoint of washing performance for protein in complex soil containing protein and liquid oil.

The washing liquid of the present invention can contain component (b) in an amount of preferably 0.0001 mass % or more, more preferably 0.0002 mass % or more, further preferably 0.0003 mass % or more, furthermore preferably 0.0005 mass % or more, furthermore preferably 0.001 mass % or more, furthermore preferably 0.002 mass % or more and furthermore preferably 0.003 mass % or more, and preferably 2 mass8 or less, more preferably 1 mass8 or less, further preferably 0.1 mass % or less and furthermore preferably 0.01 mass % or less from the viewpoint of washing performance for liquid oil in complex soil containing protein and liquid oil.

In the present invention, the ranges of the contents of components (a) and (b) in the washing liquid can each be set by arbitrarily selecting numerical values described above and combining them.

A pH of the washing liquid of the present invention is preferably 6 or more, more preferably 6.2 or more and further preferably 6.5 or more, and preferably 10.5 or less, more preferably 10.2 or less, further preferably 10 or less, furthermore preferably 9 or less and furthermore preferably 8 or less from the viewpoint of reducing the risk of chemical injuries and reducing environmental burdens by reducing the pH of wastewater.

In the method for washing tableware of the present invention, the washing liquid is brought into contact with the tableware for, for example, 20 seconds or more, further 30 seconds or more and further 40 seconds or more from the viewpoint of washing performance for complex soil containing protein and liquid oil, and 600 seconds or less, further 300 seconds or less and further 180 seconds or less from the viewpoint of washing efficiency.

In the method for washing tableware of the present invention, a temperature of the washing liquid can be, for example, 30° C. or more, further 35° C. or more and further 40° C. or more, and 90° C. or less, further 80° C. or less and further 70° C. or less.

In the method for washing tableware of the present invention, a flow rate when the washing liquid is brought into contact with the tableware can be preferably 5 m/min or more, more preferably 10 m/min or more and further preferably 50 m/min or more, and preferably 2000 m/min or less, more preferably 1000 m/min or less and more preferably 500 m/min or less from the viewpoint of washing performance for complex soil containing protein and liquid oil.

The method for washing tableware of the present invention is intended for washing complex soil containing animal protein and lipid, and containing vegetable liquid oil.

Soil containing animal protein and lipid may be, for example, soil containing protein derived from egg yolk and lipid.

Soil containing vegetable liquid oil may be, for example, soil containing liquid oil such as salad oil.

After the washing liquid is brought into contact with the tableware, the tableware is rinsed with water. A temperature of water for rinsing the tableware is 50° C. or more, preferably 55° C. or more and more preferably 60° C. or more, and 80° C. or less.

A time for rinsing the tableware is 4 seconds or more and preferably 5 seconds or more, and 10 seconds or less and preferably 9 seconds or less.

A flow rate of rinsing water can be preferably 5 m/min or more, more preferably 10 m/min or more and further preferably 100 m/min or more, and preferably 2500 m/min or less, more preferably 2000 m/min or less, further preferably 1500 m/min or less, further preferably 250 m/min or less and furthermore preferably 150 m/min or less.

In the present invention, an automatic dishwasher may be any dishwasher generally available on the market, and an automatic dishwasher for home use can also be used, although an automatic dishwasher for business use is preferable. In washing with a dishwasher for business use, the detergent composition for automatic dishwashers of the present invention is generally mixed with water and used as a washing liquid. In such washing, a certain amount of the composition is arbitrarily transferred through a supplying device to the inside of a dishwasher for business use to maintain an appropriate concentration of the washing liquid. For example, the detergent composition for automatic dishwashers of the present invention is pumped and supplied through a tube dedicated to a dishwasher for business use inserted directly into a container made of plastic or the like filled with the composition. The washing liquid is then supplied to the inside of the dishwasher for business use.

The present invention also discloses the following aspects in addition to the above embodiments.
<1>

A detergent composition for automatic dishwashers, containing the following component (a), the following component (b) and water,
component (a): an inorganic reducing agent with an oxidation-reduction potential of +71 mV or less; and
component (b): a nonionic surfactant,
wherein a mass ratio of a content of component (a) to a content of component (b), (a)/(b), is 0.3 or more and 4.5 or less, and a pH of the composition at 25° C. is 6 or more and 11 or less.
<2>

The detergent composition for automatic dishwashers according to <1>, wherein the content of component (a) in the detergent composition for automatic dishwashers is preferably 0.5 mass8 or more, more preferably 0.7 mass % or more, further preferably 1 mass % or more and furthermore preferably 2 mass % or more, and preferably 20 mass % or less, more preferably 18 mass % or less, further preferably 15 mass % or less, furthermore preferably 10 mass % or less, furthermore preferably 5 mass % or less, and furthermore preferably 3 mass % or less.
<3>

The detergent composition for automatic dishwashers according to <1> or <2>, wherein component (a) is an inorganic reducing agent with an oxidation-reduction potential of +71 mV or less, preferably +60 mV or less, more preferably +55 mV or less and further preferably +50 mV or less, and preferably 0 mV or more and more preferably 3 mV or more.
<4>

The detergent composition for automatic dishwashers according to any of <1> to <3>, wherein component (a) is one or more selected from a sulfite, a disulfate, a thiosulfate and an iodide salt, preferably one or more selected from sodium sulfite (+50 mV), potassium sulfite (+50 mV), sodium disulfate (+17 mV), potassium disulfate (+17 mV), potassium iodide (+28 mV), sodium iodide (+28 mV), sodium thiosulfate (+5 mV) and potassium thiosulfate (+5 mV), more preferably one or more selected from sodium sulfite, sodium disulfate, potassium iodide and sodium thiosulfate, further preferably one or more selected from sodium sulfite, sodium disulfate and sodium thiosulfate, furthermore preferably one or more selected from sodium sulfite and sodium thiosulfate, and furthermore preferably sodium sulfite.
<5>

The detergent composition for automatic dishwashers according to any of <1> to <4>, wherein the content of component (b) in the detergent composition for automatic dishwashers is preferably 0.6 mass % or more, more preferably 0.7 mass % or more, further preferably 0.8 mass % or more, furthermore preferably 1 mass % or more and furthermore preferably 2 mass % or more, and preferably 20 mass % or less, more preferably 18 mass % or less, further preferably 15 mass % or less, furthermore preferably 10 mass % or less, furthermore preferably 5 mass % or less and furthermore preferably 3 mass % or less.
<6>

The detergent composition for automatic dishwashers according to any of <1> to <5>, wherein component (b) is one or more selected from a compound represented by the following general formula (b1), a compound represented by the following general formula (b2) and a compound represented by the following general formula (b3), and is preferably a compound represented by the following general formula (b1):

R^{1b}b—O-[(EO)ₘ/(PO)ₙ]-H (b1)

wherein R^{1b} is a hydrocarbon group with 6 or more and 18 or less carbons, EO represents an ethyleneoxy group, PO represents a propyleneoxy group, m represents an average number of added moles of EO, n represents an average number of added moles of PO, m is a number of 1 or more and 30 or less, n is a number of 2 or more and 50 or less, and “/” means that EO and PO may be at random or in block, the order of addition of EO and PO being arbitrary,

H—O-(EO)ₐ-(PO)_{b}-(EO)_{c}-H (b2), and

H—O-(PO)ₐ-(EO)ₑ-(PO)_{f}-H (b3)

wherein EO represents an oxyethylene group, PO represents an oxypropylene group, and a, b, c, d, e and f are average numbers of added moles, and each independently a number of 2 or more and 30 or less.
<7>

The detergent composition for automatic dishwashers according to any of <1> to <6>, wherein in the detergent composition for automatic dishwashers, the mass ratio of the content of component (a) to the content of component (b), (a)/(b), is preferably 0.5 or more and more preferably 1 or more, and preferably 4 or less, more preferably 3 or less, further preferably 2 or less, and furthermore preferably 1.5 or less.
<8>

The detergent composition for automatic dishwashers according to any of <1> to <7>, wherein the pH of the composition at 25° C. is preferably 6.2 or more and more preferably 6.5 or more and preferably 10 or less, more preferably 9 or less, further preferably 8 or less, and furthermore preferably 7 or less.
<9>

The detergent composition for automatic dishwashers according to any of <1> to <8>, wherein a content of water in the detergent composition for automatic dishwashers is 20 mass % or more, further 30 mass % or more, further 50 mass % or more, further 55 mass or more, further 60 mass % or more, further 65 mass % or more, and further 70 mass % or more.
<10>

A method for washing tableware including, washing, by using an automatic dishwasher, tableware adhered with soil with a washing liquid prepared by diluting the detergent composition for automatic dishwashers according to any of <1> to <9> with water.
<11>

The method for washing tableware according to <10>, wherein the washing liquid is prepared by diluting the detergent composition for automatic dishwashers according to any of <1> to <9> with water by a factor of more than one and further 300 or more, and 2, 000 or less and further 1500 or less.
<12>

The method for washing tableware according to <10> or <11>, wherein the washing liquid is brought into contact with the tableware for 20 seconds or more, further 30 seconds or more and further 40 seconds or more, and 600 seconds or less, further 300 seconds or less and further 180 seconds or less.
<13>

The method for washing tableware according to any of <10> to <12>, wherein a temperature of the washing liquid is 30° C. or more, further 35° C. or more and further 40° C. or more, and 90° C. or less, further 80° C. or less and further 70° C. or less.
<14>

The method for washing tableware according to any of <10> to <13>, wherein a pH of the washing liquid is preferably 6 or more, more preferably 6.2 or more and further preferably 6.5 or more, and preferably 10.5 or less, more preferably 10.2 or less, further preferably 10 or less, furthermore preferably 9 or less, and furthermore preferably 8 or less.

### EXAMPLES

The formulation components used in examples and comparative examples are listed collectively below.

<Component (a)>
Sodium sulfite: oxidation-reduction potential 50 mV, manufactured by FUJIFILM Wako Pure Chemical Corporation
Sodium disulfate: oxidation-reduction potential 17 mV, manufactured by FUJIFILM Wako Pure Chemical Corporation
Potassium iodide: oxidation-reduction potential 28 mV, manufactured by FUJIFILM Wako Pure Chemical Corporation
Sodium thiosulfate: oxidation-reduction potential 5 mV, manufactured by FUJIFILM Wako Pure Chemical Corporation
   <Component (a′) (Comparative Component for Component (a))>
Sodium dithionite: oxidation-reduction potential 76 mV, manufactured by FUJIFILM Wako Pure Chemical Corporation
Thiourea dioxide: oxidation-reduction potential 147 mV, manufactured by FUJIFILM Wako Pure Chemical Corporation
Glutathione: oxidation-reduction potential-90 mV, manufactured by FUJIFILM Wako Pure Chemical Corporation

An oxidation-reduction potential of component (a) or (a′) was measured by the method below.

Distilled water was added to component (a) or (a′) such that the concentration was 0.016 mol/L, and 1 mol/L hydrochloric acid and/or sodium hydroxide were added to adjust the pH to 7.5 to prepare a conditioned liquid. The temperature of the conditioned liquid was adjusted to 60° C., and the oxidation-reduction potential was measured with an ORP measuring instrument manufactured by CEM corporation Co., Ltd. (ORP5 PEN ORP meter).

<Component (b)>
SOFTANOL EP7085: a compound of the general formula (b1) in which R^{1b} is a branched secondary alkyl group with 12 to 14 carbons, m is 7 and n is 8.5, and an ethyleneoxy group and a propyleneoxy group are added in block in this order; “SOFTANOL EP7085” manufactured by NIPPON SHOKUBAI CO., LTD.
EMULGEN LS-106: a compound of the general formula (b1) in which R^{1b} is a primary alkyl group with 12 to 14 carbons, m is 6 and n is 1.5 and an ethyleneoxy group and a propyleneoxy group are added in block in this order; “EMULGEN LS-106” manufactured by Kao Corporation.
Pluronic RPE2520: a compound represented by the general formula (b3), weight average molecular weight 3,100, propylene oxide/ethylene oxide ratio=80/20, “Pluronic RPE2520” manufactured by BASF Japan.

Using the detergent compositions for automatic dishwashers shown in Table 1, washing power for complex soil containing egg yolk and salad oil was evaluated according to the procedures below. The results are shown in Table 1. Note that adjustments with sodium hydroxide and/or sulfuric acid were made as necessary to obtain the pH of the compositions in Table 1.
(1) The mass of a SUS stainless-steel tray (outer dimensions: width 258 mm×depth 177 mm×height 18 mm, inner dimensions of bottom: 235 mm×155 mm) (mass A) was measured.
(2) 1.5 g of egg yolk was uniformly spread on the bottom of the stainless-steel tray with a brush in an area of 180 mm×100 mm. This was allowed to stand and dried in constant temperature bath FC-612 manufactured by ADVANTEC heated to 30° C. for 30 minutes. After drying, 1.5 g of salad oil manufactured by The Nisshin Oillio Group, Ltd. was spread on the bottom of the stainless-steel tray in an area of 235 mm×155 mm.
(3) The mass of the stainless-steel tray after spreading the egg yolk and the salad oil (mass B) was measured.
(4) JWE-680A manufactured by HOSHIZAKI CORPORATION was used as the dishwasher. Each of the detergent compositions for automatic dishwashers in Table 1 was diluted at 0.2 mass % with water to give a washing liquid, and the stainless-steel tray on which egg yolk and salad oil were applied was washed at a temperature of 60° C. for a period of time of 40 seconds at a flow rate of the washing liquid of 270 m/min. A few seconds later, the tray was rinsed with rinsing water at 80° C. for 6 seconds at a flow rate of rinsing water of 1,000 m/min. Note that part of the washing liquid was extracted and the pH at 25° C. was measured.
(5) The mass of the stainless-steel tray after washing (mass C) was measured, and the washing rate of the complex soil of protein and lipid was calculated from the rate of mass change. The rate of mass change is specifically determined by the following formula. The results of the washing rate are shown in Table 1. The washing rate is preferably 85% or more.

$$Rate of mass change ( \% ) = \{ [ B - C ] / [ B - A ] \} \times 100$$

(6) Further, both sides of the stainless-steel tray after washing were checked for cloudiness due to oil residue. The results are shown in Table 1.

TABLE 1

| | | | | Example | | | | | | |
|---|---|---|---|---|---|---|---|---|---|---|
| | | | | 1 | 2 | 3 | 4 | 5 | 6 | 7 |
| Detergent | Composition | (a) | Sodium | 2.5 | | | | 2.5 | 2.5 | 0.75 |
| composition | (mass %) | | sulfite | | | | | | | |
| for | | | Sodium | | 2.5 | | | | | |
| automatic | | | disulfate | | | | | | | |
| dishwashers | | | Potassium | | | 2.5 | | | | |
| | | | iodide | | | | | | | |
| | | | Sodium | | | | 2.5 | | | |
| | | | thiosulfate | | | | | | | |
| | | (a′) | Sodium | | | | | | | |
| | | | dithionite | | | | | | | |
| | | | Thiourea | | | | | | | |
| | | | dioxide | | | | | | | |
| | | | Glutathione | | | | | | | |
| | | (b) | SOFTANOL | 2 | 2 | 2 | 2 | | | 2 |
| | | | EP7085 | | | | | | | |
| | | | EMULGEN | | | | | 2 | | |
| | | | LS-106 | | | | | | | |
| | | | Pluronic | | | | | | 2 | |
| | | | RPE2520 | | | | | | | |

| | | | | | | | |
|---|---|---|---|---|---|---|---|
| Water | Balance | Balance | Balance | Balance | Balance | Balance | Balance |
| Total | 100 | 100 | 100 | 100 | 100 | 100 | 100 |

| | | | | | | | |
|---|---|---|---|---|---|---|---|
| (a)/(b) (mass ratio) | 1.25 | 1.25 | 1.25 | 1.25 | 1.25 | 1.25 | 0.375 |
| pH of undiluted solution (25° C.) | 7.0 | 7.0 | 7.0 | 7.0 | 7.0 | 7.0 | 7.0 |
| pH of product diluted with water | 7.5 | 7.5 | 7.5 | 7.5 | 7.5 | 7.5 | 7.5 |
| at 0.2 mass % (25° C.) | | | | | | | |
| Oxidation-reduction potential | 50 | 17 | 28 | 5 | 50 | 50 | 50 |
| (mV) of (a) or (a′) | | | | | | | |

| | | | | | | | |
|---|---|---|---|---|---|---|---|
| Washing rate (%) | 91 | 87 | 86 | 88 | 90 | 89 | 85 |
| Cloudiness due to oil residue | None | None | None | None | None | None | None |

| | | | | Example | Comparative Example | | | | |
|---|---|---|---|---|---|---|---|---|---|
| | | | | 8 | 1 | 2 | 3 | 4 | 5 |
| Detergent | Composition | (a) | Sodium | 2.5 | | | | 0.5 | 2.5 |
| composition | (mass %) | | sulfite | | | | | | |
| for | | | Sodium | | | | | | |
| automatic | | | disulfate | | | | | | |
| dishwashers | | | Potassium | | | | | | |
| | | | iodide | | | | | | |
| | | | Sodium | | | | | | |
| | | | thiosulfate | | | | | | |
| | | (a′) | Sodium | | 2.5 | | | | |
| | | | dithionite | | | | | | |
| | | | Thiourea | | | 2.5 | | | |
| | | | dioxide | | | | | | |
| | | | Glutathione | | | | 2.5 | | |
| | | (b) | SOFTANOL | 0.75 | 2 | 2 | 2 | 2 | 0.5 |
| | | | EP7085 | | | | | | |
| | | | EMULGEN | | | | | | |
| | | | LS-106 | | | | | | |
| | | | Pluronic | | | | | | |
| | | | RPE2520 | | | | | | |

| | | | | | | |
|---|---|---|---|---|---|---|
| Water | Balance | Balance | Balance | Balance | Balance | Balance |
| Total | 100 | 100 | 100 | 100 | 100 | 100 |

| | | | | | | |
|---|---|---|---|---|---|---|
| (a)/(b) (mass ratio) | 3.33 | 0 | 0 | 0 | 0.25 | 5 |
| pH of undiluted solution (25° C.) | 7.0 | 7.0 | 7.0 | 7.0 | 7.0 | 7.0 |
| pH of product diluted with water | 7.5 | 7.5 | 7.5 | 7.5 | 7.5 | 7.5 |
| at 0.2 mass % (25° C.) | | | | | | |
| Oxidation-reduction potential | 50 | 76 | 147 | −90 | 50 | 50 |
| (mV) of (a) or (a′) | | | | | | |

| | | | | | | |
|---|---|---|---|---|---|---|
| Washing rate (%) | 87 | 82 | 80 | 78 | 83 | 84 |
| Cloudiness due to oil residue | None | None | None | None | None | Cloudy |

1. A detergent composition for automatic dishwashers, comprising:
component (a): one or more inorganic reducing agents with an oxidation-reduction potential of +71 mV or less selected from the group consisting of a sulfite, a disulfate, and a thiosulfate;
component (b): a nonionic surfactant; and
water;
wherein a content of the component (a) is 2 mass % to 20 mass %, a mass ratio of the content of the component (a) to a content of the component (b), (a)/(b), is 0.3 to 4.5, and a pH of the composition at 25° C. is 6 to 11.

2. (canceled)

3. The detergent composition of claim 1, wherein the component (a) is one or more inorganic reducing agents with an oxidation-reduction potential of +0 m V to +71 mV selected from the group consisting of a sulfite, a disulfate, and a thiosulfate.

4. (canceled)

5. The detergent composition of claim 1, wherein the component (a) is one or more selected from the group consisting of sodium sulfite, potassium sulfite, sodium disulfate, potassium disulfate, sodium thiosulfate, and potassium thiosulfate.

6. The detergent composition of claim 1, wherein the component (b) is a compound of formula (b1):
R^{1b}—O-[(EO)ₘ/(PO)ₙ]-H (b1)
wherein R^{1b} is a hydrocarbon group with 6 to 18 carbon atoms, EO represents an ethyleneoxy group, PO represents a propyleneoxy group, m represents an average number of added moles of EO, n represents an average number of added moles of PO, m is a number of 1 to 30, n is a number of 2 to 50, and “/” means that EO and PO may be at random or in block, the order of addition of EO and PO being arbitrary.

7. The detergent composition of claim 1, wherein the pH of the composition at 25° C. is 6 to 8.

8. A method for washing tableware, the method comprising:
washing, with an automatic dishwasher, tableware adhered with soil with a washing liquid prepared by diluting the detergent composition of claim 1 with water.

9. The method of claim 8, wherein the washing liquid is prepared by diluting the detergent composition with water by a factor of one to 2,000.

10. The method of claim 8, wherein the washing liquid is brought into contact with the tableware for 20 seconds to 600 seconds.

11. The method of claim 8, wherein a temperature of the washing liquid is 30° C. to 90° C.

12. The detergent composition of claim 1, wherein the content of the component (b) is 1 mass % to 20 mass %.

13. The detergent composition of claim 1, wherein the mass ratio of the content of the component (a) to the content of the component (b), (a)/(b), is 0.5 to 4.

14. The detergent composition of claim 1, wherein a content of water is 20 mass % or more.

15. The detergent composition of claim 1, wherein the component (b) is a compound of formula (b2):
H—O-(EO)ₐ-(PO)_{b}-(EO)_{c}-H (b2)
wherein EO represents an ethyleneoxy group, PO represents a propyleneoxy group, and a, b, and c are each independently a number of 2 to 30.

16. The detergent composition of claim 1, wherein the component (b) is a compound of formula (b3):
H—O-(PO)_{d}-(EO)ₑ-(PO)_{f}-H (b3)
wherein EO represents an ethyleneoxy group, PO represents a propyleneoxy group, and d, e, and f are each independently a number of 2 to 30.

17. The detergent composition of claim 6, wherein the mass ratio of the content of the component (a) to the content of the component (b), (a)/(b), is 0.5 to 4.

18. The method of claim 8, wherein the washing liquid comprises component (a) in an amount of 0.0001 mass % to 5 mass %.

19. The method of claim 8, wherein the washing liquid comprises component (b) in an amount of 0.0001 mass % to 2 mass %.

20. The method of claim 9, wherein a pH of the washing liquid is 6 to 10.5.

21. The detergent composition of claim 15, wherein the mass ratio of the content of the component (a) to the content of the component (b), (a)/(b), is 0.5 to 4.

22. The detergent composition of claim 16, wherein the mass ratio of the content of the component (a) to the content of the component (b), (a)/(b), is 0.5 to 4.
